(19) United States
(12) Patent Application Publication
(10) Pub. No.: US 2025/0140853 A1
(43) Pub. Date: May 1, 2025

(54) Electrode for Battery and Battery

(71) Applicant: TOYOTA JIDOSHA KABUSHIKI KAISHA, Toyota-shi Aichi-ken (JP)

(72) Inventors: Daiki MAEDA, Toyota-shi Aichi-ken (JP); Masataka TOMITA, Nisshin-shi Aichi-ken (JP); Junta TAKASU, Nagoya-shi Aichi-ken (JP); Yuusuke SHIMIZU, Kosai-shi Shizuoka-ken (JP)

(73) Assignee: TOYOTA JIDOSHA KABUSHIKI KAISHA, Toyota-shi Aichi-ken (JP)

(21) Appl. No.: 18/927,366

(22) Filed: Oct. 25, 2024

(30) Foreign Application Priority Data
Oct. 30, 2023 (JP) 2023-185365

(51) Int. Cl. H01M 4/583; H01M 4/02; H01M 4/36; H01M 10/052

(52) U.S. Cl. CPC H01M 4/583; H01M 4/366; H01M 10/052; H01M 2004/021; H01M 2004/027

(57) ABSTRACT

An electrode for a battery comprises a base material and a negative electrode active material layer. A cross section of the negative electrode active material layer parallel to a thickness direction includes a first region and a second region. In the thickness direction, the first region is interposed between the second region and the base material. The first region includes a first active material and a first binder. The second region includes a second active material and a second binder. Either a set of relationships of “A2<A1” and “B2<B1” or a set of relationships of expressions “A2>A1” and “B2>B1” is satisfied. A1 represents an aspect ratio of the first active material. A2 represents an aspect ratio of the second active material. B1 represents an area fraction of the first binder in the first region. B2 represents an area fraction of the second binder in the second region.

### CROSS REFERENCE TO RELATED APPLICATIONS

This nonprovisional application is based on Japanese Patent Application No. 2023-185365 filed on Oct. 30, 2023, with the Japan Patent Office, the entire contents of which are hereby incorporated by reference.

### BACKGROUND OF THE DISCLOSURE

### Field of the Disclosure

The present disclosure relates to an electrode for a battery and a battery.

### Description of the Background Art

Japanese Patent Laying-Open No. 10-284059 discloses an electrode in which a greater amount of binder is distributed at the interface between a negative electrode material layer and a current collector, than in the outer surface of the negative electrode material layer.

### SUMMARY OF THE DISCLOSURE

Researches have been conducted on orienting an active material in a negative electrode active material layer. For example, when an active material with a high aspect ratio is used, the active material may be oriented in the negative electrode active material layer. With an active material thus oriented, rate performance is expected to be improved. However, generally, during the production process of an electrode, a negative electrode active material layer is subjected to press work. When the active material is crushed at the time of press work, the state of orientation of the active material can change.

An object of the present disclosure is to improve rate performance.

Hereinafter, the technical configuration and effects of the present disclosure will be described. It should be noted that the action mechanism includes presumption. The action mechanism does not limit the technical scope of the present disclosure.
1. An electrode for a battery comprises a base material and a negative electrode active material layer. The negative electrode active material layer is placed on a surface of the base material. A cross section of the negative electrode active material layer parallel to a thickness direction includes a first region and a second region. In the thickness direction, the first region is interposed between the second region and the base material. The first region includes a first active material and a first binder. The second region includes a second active material and a second binder. Either a set of relationships of the following expression (1) and the following expression (2) or a set of relationships of the following expression (3) and the following expression (4) is satisfied.

$$A 2 < A 1 \qquad ( 1 )$$

$$B 2 < B 1 \qquad ( 2 )$$

$$A 2 < A 1 \qquad ( 3 )$$

$$B 2 < B 1 \qquad ( 4 )$$

In the expression (1) to the expression (4), A1 represents an aspect ratio of the first active material. A2 represents an aspect ratio of the second active material. B1 represents an area fraction of the first binder in the first region. B2 represents an area fraction of the second binder in the second region.

The first region is closer to the base material than the second region is. The aspect ratio of the active material in the first region is different from that in the second region. The area fraction of the binder in a cross section of the negative electrode active material layer represents the amount of presence of the binder. The amount of presence of the binder in the first region is different from that in the second region. As seen in the relationships of the expression (1) and the expression (2) or in the relationships of the expression (3) and the expression (4), the amount of presence of the binder is relatively great in one of the first region and the second region in which the aspect ratio of the active material is relatively high. In a region that includes an active material with a high aspect ratio, the active material may be strongly orientated. In that region, because the amount of presence of the binder is great, the state of orientation of the active material is expected to be fixed well. Further, the other region in which the aspect ratio of the active material is relatively low and the amount of presence of the binder is relatively small may function as a cushion at the time of press work. As a result, the load applied to the oriented active material may be reduced. That is, at the time of press work, the state of orientation of the active material tends not to change. With the state of orientation of the active material being maintained, ionic conduction is expected to be facilitated.

The binder may inhibit ionic conduction. When the amount of presence of the binder is excessively great throughout the negative electrode active material layer, rate performance can be degraded. When the amount of presence of the binder is relatively small in one of the first region and the second region, desired ionic conduction is expected to take place throughout the negative electrode active material layer. Due to the synergistic effect of the above-described actions, rate performance is expected to be improved.
2. The electrode for a battery according to “1” above may include the following configuration, for example.

The negative electrode active material layer has a tortuosity of 1.8 or less.

The lower the tortuosity is, the more enhanced the rate performance is expected to be. When the state of orientation of the active material in the negative electrode active material layer is good, a tortuosity of 1.8 or less may be achieved.
3. The electrode for a battery according to “1” or “2” above may include the following configuration, for example.

A relationship of the following expression (5) is further satisfied.

$$0.05 \leq {I}_{110} / {I}_{002} \qquad ( 5 )$$

In the expression (5), I₁₁₀ represents a diffraction intensity of a (110) plane in an X-ray diffraction profile of the negative electrode active material layer. I₀₀₂ represents a diffraction intensity of a (002) plane in the X-ray diffraction profile of the negative electrode active material layer.

“I₁₁₀/I₀₀₂” is an index of the state of orientation. Hereinafter, “I₁₁₀/I₀₀₂” is also called “an orientation degree”. The greater the value of the orientation degree is, the more enhanced the rate performance is expected to be. When the state of orientation of the active material in the negative electrode active material layer is good, a orientation degree of 0.05 or more may be achieved.
4. The electrode for a battery according to any one of “1” to “3” above may include the following configuration, for example.

Among the set of relationships of the expression (1) and the expression (2) and the set of relationships of the expression (3) and the expression (4), only the set of relationships of the expression (1) and the expression (2) is satisfied.

When an active material with a high aspect ratio is placed in the first region, the active material may be strongly orientated in the first region. At the time of press work, the first region (a lower layer) does not come into direct contact with a rolling roll. As a result, it is expected that the state of orientation in the first region tends not to change at the time of press work.
5. The electrode for a battery according to any one of “1” to “4” above may include the following configuration, for example.

Each of the first active material and the second active material independently includes artificial graphite.
6. The electrode for a battery according to any one of “1” to “5” above may include the following configuration, for example.

The negative electrode active material layer has a weight of 20 mg/cm² or more per unit area. The negative electrode active material layer has a density from 1.1 to 1.6 g/cm³.

A high-density electrode may have a weight of 20 mg/cm² or more per unit area and a density from 1.1 to 1.6 g/cm³. In a high-density electrode, a large load is applied to the active material at the time of press work, so the state of orientation of the active material tends to change. With the configuration of “1” above, even in a high-density electrode, the state of orientation is expected to be good.
7. The electrode for a battery according to any one of “1” to “6” above may include the following configuration, for example.

A relationship of the following expression (6) is further satisfied.

$$0.5 \leq Tx / ( T 1 + T 2 ) \leq 0.7 \qquad ( 6 )$$

In the expression (6), T1 represents a thickness of the first region. T2 represents a thickness of the second region. When the relationship of the expression (1) is satisfied, Tx represents the thickness of the first region. When the relationship of the expression (3) is satisfied, Tx represents the thickness of the second region.

In a region that includes an active material with a high aspect ratio, the active material may be strongly orientated. When the ratio of the thickness of the region in which the active material is strongly orientated is at least 50% of the total, rate performance is expected to be improved. In the region in which the active material is strongly orientated, the amount of presence of the binder is great. When the ratio of that region is 70% or less, the amount of presence of the binder is expected to fall within a proper range.
8. The electrode for a battery according to any one of “1” to “7” above may include the following configuration, for example.

A relationship of the following expression (7) is further satisfied.

$$1.8 \% \leq \vert B 1 - B 2 \vert \qquad ( 7 )$$

When the absolute value of the difference between the area fraction of the binder in the first region and the area fraction of the binder in the second region is 1.8% or more, a desired state of orientation tends to be formed.
9. The electrode for a battery according to any one of “1” to “8” above may include the following configuration, for example.

A relationship of the following expression (8) is further satisfied.

$$1.8 \leq Ax \qquad ( 8 )$$

In the expression (8), when the relationship of the expression (1) is satisfied, Ax represents the aspect ratio of the first active material. When the relationship of the expression (3) is satisfied, Ax represents the aspect ratio of the second active material.

When the active material has an aspect ratio of 1.8 or more, a desired state of orientation tends to be formed.
10. A battery comprises the electrode for a battery according to any one of “1” to “9” above.

In the following, an embodiment of the present disclosure (which may also be simply called “the present embodiment” hereinafter) and an example of the present disclosure (which may also be simply called “the present example” hereinafter) will be described. It should be noted that neither the present embodiment nor the present example limits the technical scope of the present disclosure. The present embodiment and the present example are illustrative in any respect. The present embodiment and the present example are non-restrictive. The technical scope of the present disclosure encompasses any modifications within the meaning and the scope equivalent to the terms of the claims. For example, it is originally planned that any configurations of the present embodiment may be optionally combined.

The foregoing and other objects, features, aspects and advantages of the present disclosure will become more apparent from the following detailed description of the present disclosure when taken in conjunction with the accompanying drawings.

### BRIEF DESCRIPTION OF THE DRAWINGS

FIG. 1 is a schematic cross-sectional view illustrating an example of an electrode for a battery according to the present embodiment.

FIG. 2 is an example of mapping analysis conducted on a cross section of a negative electrode active material layer.

FIG. 3 is a schematic flowchart illustrating a method of producing an electrode for a battery according to the present embodiment.

FIG. 4 is a conceptual view illustrating an example of a battery according to the present embodiment.

FIG. 5 is a table showing a first battery configuration.

FIG. 6 is a table showing a second battery configuration.

FIG. 7 is a table showing a third battery configuration.

FIG. 8 is a table showing experiment results.

FIG. 9 shows cross-sectional SEM images of a first region and a second region in No. 1-1.

FIG. 10 is a discharge curve during discharging at 1 C.

### DESCRIPTION OF THE EMBODIMENTS

### Terms and Phrases

Terms such as “comprise”, “include”, and “have”, and other similar terms are open-ended terms. In an open-ended term, in addition to a component, an additional component may or may not be further included. The term “consist of” is a closed-end term. However, even in a configuration that is expressed by a closed-end term, impurities present under ordinary circumstances as well as an additional element irrelevant to the technique of interest may be included. The term “consist essentially of” is a semiclosed-end term. A semiclosed-end term tolerates addition of an element that does not substantially affect the fundamental, novel features of the technique of interest.

Expressions such as “may” and “can” are not intended to mean “must” (obligation) but rather mean “there is a possibility” (tolerance).

Regarding a plurality of steps, operations, processes, and the like that are included in various methods, the order for implementing those things is not limited to the described order, unless otherwise specified. For example, a plurality of steps may proceed simultaneously. For example, a plurality of steps may be implemented in reverse order.

Any geometric term should not be interpreted solely in its exact meaning. Examples of geometric terms include “parallel”, “vertical”, “orthogonal”, and the like. For example, “parallel” may mean a geometric state that is deviated, to some extent, from exact “parallel”. Any geometric term herein may include tolerances and/or errors in terms of design, operation, production, and/or the like. The dimensional relationship in each figure may not necessarily coincide with the actual dimensional relationship. For the purpose of assisting understanding for the readers, the dimensional relationship in each figure may have been changed. For example, length, width, thickness, and the like may have been changed. A part of a given configuration may have been omitted.

A numerical range such as “from m to n %” includes both the upper limit and the lower limit, unless otherwise specified. That is, “from m to n %” means a numerical range of “not less than m % and not more than n %”. Moreover, “not less than m % and not more than n %” includes “more than m % and less than n %”. Each of “not less than” and “not more than” is represented by an inequality symbol with an equality symbol, e.g., “<, >”. Each of “more than” and “less than” is represented by an inequality symbol without an equality symbol, e.g., “<, >”. Any numerical value selected from a certain numerical range may be used as a new upper limit or a new lower limit. For example, any numerical value from a certain numerical range may be combined with any numerical value described in another location of the present specification or in a table or a drawing to set a new numerical range.

All the numerical values are regarded as being modified by the term “about”. The term “about” may mean+5%, +3%, +1%, and/or the like, for example. Each numerical value may be an approximate value that can vary depending on the implementation configuration of the technique according to the present disclosure. Each numerical value may be expressed in significant figures. Unless otherwise specified, each measured value may be the average value obtained from multiple measurements performed. The number of measurements may be 3 or more, or may be 5 or more, or may be 10 or more. Generally, the greater the number of measurements is, the more reliable the average value is expected to be. Each measured value may be rounded off based on the number of the significant figures. Each measured value may include an error occurring due to an identification limit of the measurement apparatus, for example.

“Aspect ratio” is measured by the following method. A negative electrode active material layer is cut to prepare a cross-sectional sample. The resulting cross-sectional sample includes a cross section parallel to the thickness direction of the negative electrode active material layer. The examination-target part may be cleaned with a cross section polisher (registered trademark) and/or the like, for example. The cross-sectional sample is examined with an SEM (Scanning Electron Microscope) to acquire a cross-sectional SEM image. At least five cross-sectional SEM images may be prepared. In each of the cross-sectional SEM images, ten or more active material particles are randomly selected. For these selected particles, the major-axis diameter and the minor-axis diameter are measured. The major-axis diameter (φ1) refers to a diameter connecting two points located farthest apart from each other on the outline of the particle. The minor-axis diameter (φ2) refers to the longest among all the diameters orthogonal to the major-axis diameter. The aspect ratio is the ratio of the major-axis diameter to the minor-axis diameter, (φ1/φ2). The arithmetic mean of these fifty or more aspect ratios is used.

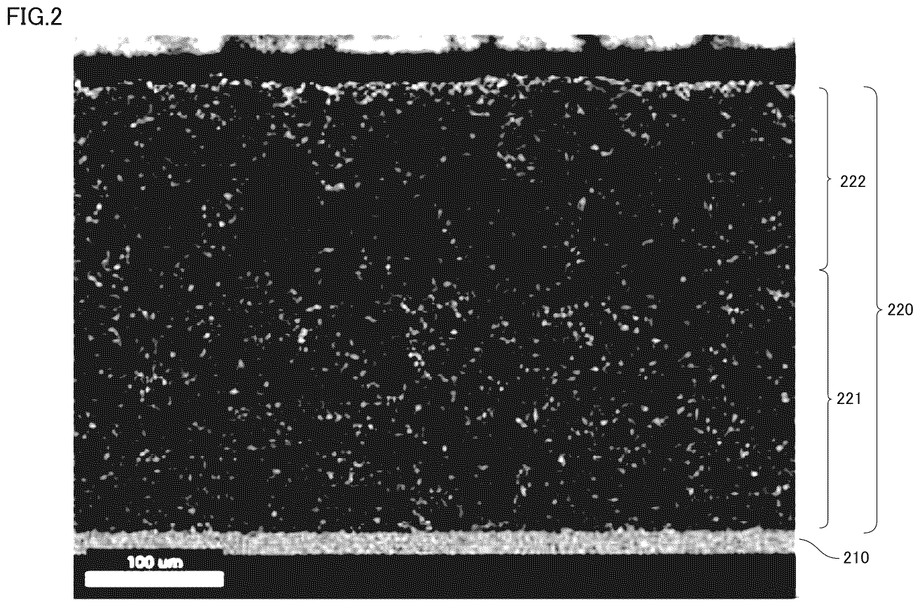

“Area fraction” is measured by the following method. For example, the binder may be stained in a cross-sectional sample of a negative electrode active material layer. For example, styrene-butadiene rubber (SBR) may be stained with osmium oxide. The cross-sectional sample is subjected to mapping analysis of the binder by SEM-EDX (Scanning Electron Microscope-Energy dispersive X-ray spectrometry). FIG. 2 is an example of mapping analysis conducted on a cross section of a negative electrode active material layer. In a negative electrode active material layer 220, white pixels correspond to the binder. In the example shown in FIG. 2, the amount of binder tends to be great in the region close to a base material 210 (a first region 221), as compared to the region far from base material 210 (a second region 222). For example, in first region 221, pixels attributable to the binder are counted. The number of pixels attributable to the binder is divided by the total number of pixels in first region 221, and thereby the area fraction of the binder in first region 221 is determined. The area fraction is expressed in percentage (%). The same applies to the area fraction of the binder in second region 222.

“Tortuosity” refers to a value determined by the following equation.

$$τ = ( {R}_{ion} \cdot A \cdot K \cdot ε ) / 2 d$$

τ: Tortuosity

Rᵢₒₙ: Ionic resistance

A: Area of negative electrode active material layer

K: Electrical conductivity of electrolyte solution

ε: Porosity of negative electrode active material layer

d: Thickness of negative electrode active material layer

“Ionic resistance” is measured by the procedure described below. Impedance of a symmetric cell is measured. A symmetric cell refers to a cell in which two equivalent electrodes are placed symmetrically. The real part of impedance at the lowest possible frequency is measured. The real part multiplied by 3 is regarded as ionic resistance. Electrical conductivity refers to the value measured at 25° C. Inside a cell comprising lithium (Li), electrolyte solution is sealed. The resistance of the cell at 10 kHz is measured by an alternating current method. From the resistance, electrical conductivity is calculated.

“Orientation degree” is measured by the following method. By XRD (X-ray diffraction), an XRD profile of a negative electrode active material layer is measured. The X-ray source is a CuKα ray. The range of measurement is “10°≤2θ≤90°”. In the XRD profile, the diffraction peak for a (002) plane may be detected within the range of “25°<2θ≤30°”. The diffraction peak for a (110) plane may be detected within the range of “75°≤2θ≤80°”. The diffraction intensity of each peak, (I₀₀₂, I₁₁₀), is measured. As shown in the above expression (5), I₁₁₀ is divided by I₀₀₂ to determine the orientation degree (I₁₁₀/I₀₀₂).

A stoichiometric composition formula represents a typical example of a compound. A compound may have a non-stoichiometric composition. For example, “Al₂O₃” is not limited to a compound where the ratio of the amount of substance (molar ratio) is “Al/O=2/3”. “Al₂O₃” represents a compound that includes Al and O in any molar ratio, unless otherwise specified. For example, the compound may be doped with a trace element. Some of Al and O may be replaced by another element.

“Derivative” refers to a compound that is derived from its original compound by at least one partial modification selected from the group consisting of substituent introduction, atom replacement, oxidation, reduction, and other chemical reactions. The position of modification may be one position, or may be a plurality of positions. “Substituent” may include, for example, at least one selected from the group consisting of alkyl group, alkenyl group, alkynyl group, cycloalkyl group, unsaturated cycloalkyl group, aromatic group, heterocyclic group, halogen atom (F, Cl, Br, I, etc.), OH group, SH group, CN group, SCN group, OCN group, nitro group, alkoxy group, unsaturated alkoxy group, amino group, alkylamino group, dialkylamino group, aryloxy group, acyl group, alkoxycarbonyl group, acyloxy group, aryloxycarbonyl group, acylamino group, alkoxycarbonylamino group, aryloxy carbonylamino group, sulfonylamino group, sulfamoyl group, carbamoyl group, alkylthio group, arylthio group, sulfonyl group, sulfinyl group, ureido group, phosphoramide group, sulfo group, carboxy group, hydroxamic acid group, sulfino group, hydrazino group, imino group, silyl group, and the like. These substituents may be further substituted. When there are two or more substituents, these substituents may be the same as one another or may be different from each other. A plurality of substituents may be bonded together to form a ring. A derivative of a polymer compound (a resin material) may also be called “a modified product”.

“Copolymer” includes at least one selected from the group consisting of unspecified-type, statistical-type, random-type, alternating-type, periodic-type, block-type, and graft-type.

“D50” refers to a particle size in volume-based particle size distribution (cumulative distribution) at which the cumulative value reaches 50%. The particle size distribution may be measured by laser diffraction.

“BET specific surface area” refers to a specific surface area that is measured by a gas adsorption method (a BET one point method). Nitrogen is used as the adsorption gas.

### <Electrode for Battery>

In the following, an electrode for a battery may be simply called “an electrode”. The electrode is in sheet form. As long as it is for a battery, the electrode may be applied to any purpose of use. For example, the electrode may be for a monopolar-type battery (a unipolar-type battery), for a bipolar-type battery, for a non-aqueous battery, for a lithium-ion battery, and/or the like.

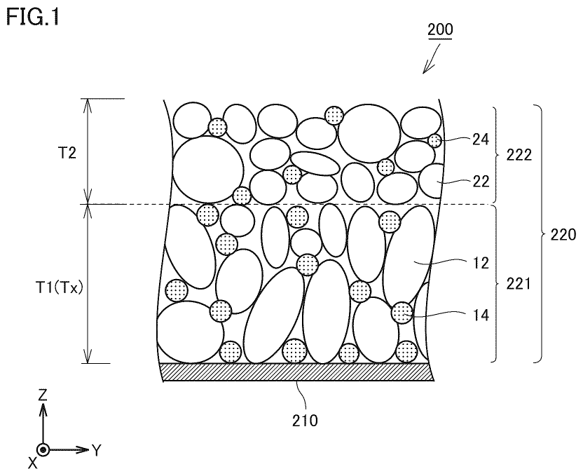

FIG. 1 is a schematic cross-sectional view illustrating an example of an electrode for a battery according to the present embodiment. For example, an electrode 200 may be a negative electrode for a monopolar-type lithium-ion battery. The cross section in FIG. 1 is parallel to the thickness direction (the Z direction) of electrode 200. Electrode 200 includes base material 210 and negative electrode active material layer 220.

Base material 210 supports negative electrode active material layer 220. Base material 210 may be in sheet form, for example. The thickness of base material 210 may be from 1 to 50 μm, or from 3 to 30 μm, or from 5 to 15 μm, for example. Base material 210 is electrically conductive. Base material 210 may include a metal foil and/or the like, for example. Base material 210 may include at least one selected from the group consisting of Cu, Ni, Zn, Pb, Al, Ti, Fe, Ag, Au, and electrically-conductive resin, for example. Base material 210 may include a Cu foil, a Cu alloy foil, and/or the like, for example. Base material 210 may have a multilayer structure, for example. Base material 210 may be formed by bonding a Cu foil and an Al foil to each other, for example.

Negative electrode active material layer 220 is placed on the surface of base material 210. Negative electrode active material layer 220 may be placed on only one side of base material 210. Negative electrode active material layer 220 may be placed on both sides of base material 210. In the case where electrode 200 is for a bipolar battery, negative electrode active material layer 220 may be placed on one side (the front side) of base material 210 while a positive electrode active material layer (not illustrated) may be placed on the other side (the back side).

The thickness of negative electrode active material layer 220 may be 10 μm or more, or 50 μm or more, or 100 μm or more, or 150 μm or more, or 200 μm or more, or 300 μm or more, or 400 μm or more, or 500 μm or more, for example. The thickness of negative electrode active material layer 220 may be 1000 μm or less, or 500 μm or less, or 400 μm or less, or 300 μm or less, or 200 μm or less, for example. The thickness of negative electrode active material layer 220 may be from 100 to 400 μm, for example.

The weight of negative electrode active material layer 220 per unit area may be 5 mg/cm² or more, or 10 mg/cm² or more, or 15 mg/cm² or more, or 20 mg/cm² or more, or 25 mg/cm² or more, or 30 mg/cm² or more, or 40 mg/cm² or more, or 50 mg/cm² or more, for example. The weight of negative electrode active material layer 220 per unit area may be 100 mg/cm² or less, or 75 mg/cm² or less, or 50 mg/cm² or less, or 40 mg/cm² or less, or 30 mg/cm² or less, for example.

The density (apparent density) of negative electrode active material layer 220 may be 0.8 g/cm³ or more, or 1.0 g/cm³ or more, or 1.2 g/cm³ or more, or 1.4 g/cm³ or more, or 1.6 g/cm³ or more, or 1.8 g/cm³ or more, for example. The density of negative electrode active material layer 220 may be 2.0 g/cm³ or less, or 1.8 g/cm³ or less, or 1.6 g/cm³ or less, or 1.4 g/cm³ or less, or 1.2 g/cm³ or less, or 1.0 g/cm³ or less, for example.

### <First Region, Second Region>

A cross section of negative electrode active material layer 220 includes first region 221 and second region 222. First region 221 may also be called “a lower layer”. In the thickness direction (the Z direction), first region 221 is interposed between second region 222 and base material 210. For example, first region 221 may be in direct contact with base material 210. For example, first region 221 may include the interface between base material 210 and negative electrode active material layer 220. Second region 222 may also be called “an upper layer”. For example, second region 222 may include a surface of negative electrode active material layer 220.

As long as including first region 221 and second region 222, negative electrode active material layer 220 may further include an additional region (such as a third region and a fourth region). For example, the additional region may be differentiated from first region 221 and second region 222 based on at least one of the composition and the structure. For example, the additional region may be provided between base material 210 and first region 221. For example, the additional region may be provided between first region 221 and second region 222. For example, the additional region may be provided between the surface of negative electrode active material layer 220 and second region 222.

First region 221 includes a first active material 12 and a first binder 14. Second region 222 includes a second active material 22 and a second binder 24. Each of first active material 12 and second active material 22 is negative electrode active material. The chemical composition of first active material 12 may be the same as, or may be different from, the chemical composition of second active material 22. Each of first active material 12 and second active material 22 may independently include at least one selected from the group consisting of natural graphite and artificial graphite. As long as including first active material 12 and second active material 22, negative electrode active material layer 220 may further include other negative electrode active materials. Negative electrode active material layer 220 may include at least one selected from the group consisting of silicon (Si), silicon oxide (SiO), silicon-carbon composite material (Si—C), silicon-based alloy, tin, tin oxide, and lithium titanate, for example. The Si—C may be formed by dispersing a Si microparticle inside a carbon particle, for example. The mass fraction of these other negative electrode active materials to the negative electrode active material as a whole may be 50% or less, or 40% or less, or 30% or less, or 20% or less, or 10% or less, or 5% or less, or 1% or less, for example.

Each of first active material 12 and second active material 22, independently, may have a D50 from 1 to 50 μm, or from 5 to 30 μm, or from 10 to 25 μm, for example. Each of first active material 12 and second active material 22, independently, may have a BET specific surface area from 0.5 to 5 m²/g, or from 1 to 4 m²/g, or from 1.5 to 3 m²/g.

The chemical composition of first binder 14 may be the same as, or may be different from, the chemical components of second binder 24. Each of first binder 14 and second binder 24, independently, may include at least one selected from the group consisting of SBR, acrylate butadiene rubber (ABR), polyacrylonitrile (PAN), polyvinylidene difluoride (PVdF), polytetrafluoroethylene (PTFE), acrylic resin (acrylic acid ester copolymer), methacrylic resin (methacrylic acid ester copolymer), polyvinyl alcohol (PVA), and derivatives of these, for example. The amount of the binder to be used relative to 100 parts by mass of the active material may be from 0.1 to 10 parts by mass, or from 1 to 6.5 parts by mass, or from 2 to 6.5 parts by mass, or from 3 to 6.5 parts by mass, or from 4 to 6.5 parts by mass, or from 5 to 6.5 parts by mass, for example.

First region 221 and second region 222 satisfy a particular relationship in terms of the aspect ratio of the active material and the area fraction of the binder. In a certain present embodiment, relationships of the following expression (1) and the following expression (2) are satisfied.

$$A 2 < A 1 \qquad ( 1 )$$

$$B 2 < B 1 \qquad ( 2 )$$

A1: Aspect ratio of first active material 12

A2: Aspect ratio of second active material 22

B1: Area fraction of first binder 14 in first region 221

B2: Area fraction of second binder 24 in second region 222

In FIG. 1, the present embodiment that satisfies the relationships of the expression (1) and the expression (2) is schematically illustrated as an example. In first region 221, the aspect ratio of first active material 12 is high and the area fraction of first binder 14 is high. With the active material with a higher aspect ratio being placed in first region 221 (the lower layer), the state of orientation tends to be maintained.

In another present embodiment, instead of the relationships of the expression (1) and the expression (2), the relationships of the following expression (3) and the following expression (4) are satisfied. With the active material with a higher aspect ratio being placed in second region 222 (the upper layer), ion diffusion in the thickness direction of negative electrode active material layer 220 is expected to be facilitated.

$$A 2 > A 1 \qquad ( 3 )$$

$$B 2 > B 1 \qquad ( 4 )$$

As long as the above relationships are satisfied, the particle shape of each of first active material 12 and second active material 22 is not limited. Each of first active material 12 and second active material 22, independently, may include at least one selected from the group consisting of spherical particles, flake-shaped particles, needle-shaped particles, and lump-shaped particles.

Regarding the thickness of each region, the relationship of the following expression (6) may be further satisfied, for example.

$$0.5 \leq Tx / ( T 1 + T 2 ) \leq 0.7 \qquad ( 6 )$$

T1: Thickness of first region 221

T2: Thickness of second region 222

Tx: Thickness of one of first region 221 and second region 222 with a higher aspect ratio of the active material

The thickness ratio {Tx/(T1+T2)} may be 0.6 or more, or may be 0.6 or less, for example.

Regarding the area fraction of the binder, (B1, B2), the relationship of the following expression (7) may be satisfied, for example.

$$1.8 \% \leq \vert B 1 - B 2 \vert \qquad ( 7 )$$

B1: Area fraction of first binder 14 in first region 221

B2: Area fraction of second binder 24 in second region 222

The absolute value of the difference between B1 and B2, (|B1−B2|), may be 2% or more, or 2.5% or more, or 3% or more, for example. |B1−B2| may be 4% or less, or 3% or less, or 2.5% or less, for example.

The greater one of B1 and B2 may be 3.5% or more, or 4% or more, or 5% or more, for example. The greater one of B1 and B2 may be 10% or less, or 8% or less, or 6% or less, for example. The smaller one of B1 and B2 may be less than 3.5%, or 3% or less, or 2.5% or less, or 2% or less, or 1.5% or less, or 1% or less, for example. The smaller one of B1 and B2 may be 0.5% or more, or 1% or more, or 1.5% or more, or 2% or more, or 3% or more, for example.

The aspect ratio of each active material, (A1, A2), may satisfy the relationship of the following expression (8), for example.

$$1.8 \leq Ax \qquad ( 8 )$$

Ax: Greater one of A1 and A2

Ax may be 2 or more, or 2.5 or more, or 3 or more, or 3.5 or more, or 4 or more, or 4.5 or more, or 5 or more, or 5.5 or more, or 6 or more, or 6.5 or more, or 7 or more, for example. Ax may be 8 or less, or 7.5 or less, or 7 or less, or 6.5 or less, or 6 or less, or 5.5 or less, or 5 or less, or 4.5 or less, or 4 or less, or 3.5 or less, or 3 or less, for example.

The smaller one of A1 and A2, (Ay), may be less than 1.8, or 1.7 or less, or 1.6 or less, or 1.5 or less, or 1.4 or less, or 1.3 or less, or 1.2 or less, or 1.1 or less, for example. Ay may be 1 or more, or 1.1 or more, or 1.2 or more, or 1.3 or more, or 1.4 or more, or 1.5 or more, or 1.6 or more, for example.

### <Optional Components>

Negative electrode active material layer 220 may include a thickening material, for example. The thickening material may make a slurry viscous. The thickening material may include at least one selected from the group consisting of sodium alginate, carboxymethylcellulose (CMC), polyacrylic acid (PAA), and polyvinylpyrrolidone (PVP), for example. Each of the CMC, the PAA, and the like may be in the form of Na salt, Li salt, NH₄ salt, and/or the like, for example. The amount of the thickening material to be used may be, for example, from 0.1 to 2 parts by mass, or from 0.1 to 1 part by mass, or from 0.1 to 0.5 parts by mass, relative to 100 parts by mass of the active material.

Negative electrode active material layer 220 may include a conductive material, for example. The conductive material is capable of forming an electron conduction path. The conductive material may include at least one selected from the group consisting of acetylene black (AB), Ketjenblack (registered trademark), vapor grown carbon fibers (VGCFs), carbon nanotubes (CNTs), and graphene flakes (GFs), for example. The CNTs may include at least one selected from the group consisting of single-walled CNTs (SWCNTs) and multi-walled CNTs (MWCNTs). The amount of the conductive material to be used may be, for example, from 0.1 to 10 parts by mass, relative to 100 parts by mass of the active material.

Negative electrode active material layer 220 may include an inorganic filler, an organic filler, a solid electrolyte, a surface modifier, a dispersant, a lubricant, a flame retardant, a protective agent, a flux, a coupling agent, an adsorbent, and/or the like, for example. Negative electrode active material layer 220 may include a layered silicate (such as smectite, montmorillonite, bentonite, hectorite), an inorganic filler (such as solid alumina, hollow silica, boehmite), a polysiloxane compound, and/or the like, for example.

### <Orientation Degree>

The greater the orientation degree (I₁₁₀/I₀₀₂) is, the more facilitated the ionic conduction is expected to be. In the present embodiment, it is possible to achieve a great orientation degree. The orientation degree of negative electrode active material layer 220, (I₁₁₀/I₀₀₂), may be 0.03 or more, or 0.05 or more, or 0.08 or more, or 0.10 or more, or 0.12 or more, for example. In other words, the relationship of the following expression (5) may satisfied.

$$0.05 \leq {I}_{110} / {I}_{002} \qquad ( 5 )$$

I₁₁₀: Diffraction intensity of a (110) plane in an XRD profile

I₀₀₂: Diffraction intensity of a (002) plane in an XRD profile

The orientation degree may be 0.30 or less, or 0.25 or less, or 0.20 or less, or 0.15 or less, or 0.12 or less, or 0.10 or less, or 0.08 or less, or 0.05 or less, for example.

### <Tortuosity>

The lower the tortuosity is, the more facilitated the ionic conduction is expected to be. In the present embodiment, it is possible to achieve a low tortuosity. The tortuosity of negative electrode active material layer 220 may be less than 2.8, or 2.5 or less, or 2.0 or less, or 1.8 or less, for example. The tortuosity may be 0.1 or more, or 0.5 or more, or 1.0 or more, or 1.5 or more, for example.

### <Method of Producing Electrode for Battery>

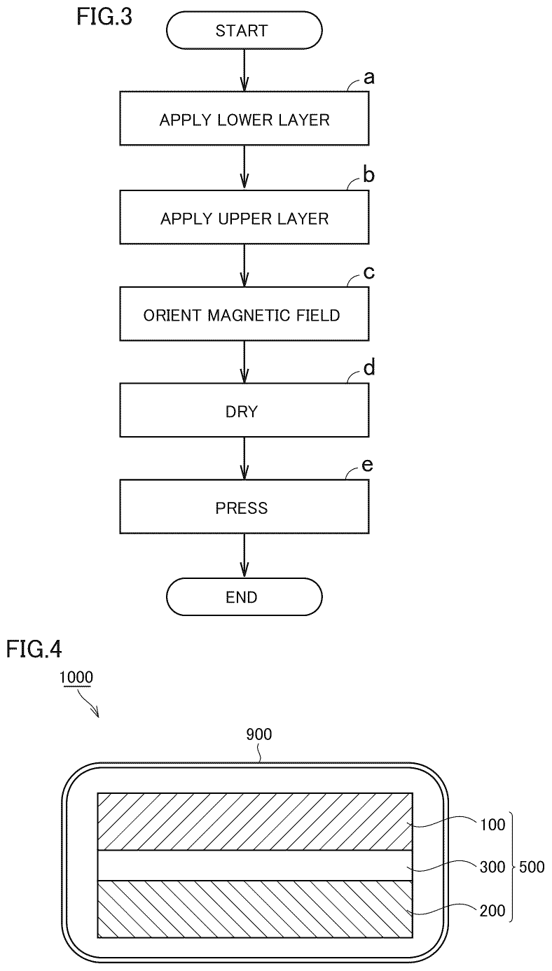

FIG. 3 is a schematic flowchart illustrating a method of producing an electrode for a battery according to the present embodiment. Hereinafter, “the method of producing an electrode for a battery according to the present embodiment” may be simply called “the present production method”. The present production method includes “(a) applying a lower layer”, “(b) applying an upper layer”, “(c) applying a magnetic field”, “(d) drying”, and “(e) pressing”.

### <(a) Applying Lower Layer>

The present production method includes applying a first slurry to the surface of base material 210 to form first region 221. The first slurry includes first active material 12, first binder 14, and a dispersion medium. For example, first active material 12, first binder 14, a thickening material, and a dispersion medium may be mixed to form the first slurry. The amount of first binder 14 to be used may be determined depending on which of first active material 12 and second active material 22 has a higher aspect ratio. Any mixing apparatus may be used. For example, a planetary mixer and/or the like may be used. The viscosity of the first slurry may be from 10000 to 30000 mPa·s, for example.

As a result of the first slurry applied to the surface of base material 210, first region 221 (a lower layer) may be formed. Any application apparatus may be used. For example, a die coater, a roll coater, and/or the like may be used.

### <(b) Applying Upper Layer>

The present production method includes applying a second slurry over first region 221 to form second region 222. The second slurry includes second active material 22, second binder 24, and a dispersion medium. For example, second active material 22, second binder 24, a thickening material, and a dispersion medium may be mixed to form the second slurry. The amount of second binder 24 to be used may be determined depending on which of first active material 12 and second active material 22 has a higher aspect ratio. The viscosity of the second slurry may be from 10000 to 30000 mPa·s, for example.

As a result of the second slurry applied over first region 221, second region 222 (the upper layer) may be formed. At this stage, both the first region 221 and the second region 222 (coating film) are in a wet state. In other words, both the first region 221 and the second region 222 include dispersion medium.

### <(c) Orienting Magnetic Field>

The present production method includes applying a magnetic field to first region 221 and second region 222. For example, a magnetic field may be applied before first region 221 is completely dried. As a result of a magnetic field applied before first region 221 is dried, a desired state of orientation is expected to be formed.

The magnetic field may be applied in the thickness direction of first region 221 and second region 222, for example. The active material included in first region 221 and second region 222 may be oriented in response to the magnetic field. The active material may be oriented in such a manner that the major axis extends in the thickness direction (the Z direction). The higher the aspect ratio is, the more oriented the active material tends to be. The magnetic flux density of the magnetic field and the application duration may be adjusted so that a desired state of orientation is to be achieved. The magnetic flux density may be from 100 to 1000 mT, for example. The application duration may be from 1 to 60 minutes, for example.

### <(d) Drying>

The present production method includes drying first region 221 and second region 222 to form negative electrode active material layer 220. By drying, the dispersion medium may be removed. Any drying apparatus may be used. For example, a hot-air drying apparatus and/or the like may be used. The drying temperature may be from 40 to 80° C., or from 40 to 60° C., for example. By the removal of the dispersion medium, electrode 200 may be completed.

### <(e) Pressing>

The present production method may include compressing negative electrode active material layer 220, for example. Negative electrode active material layer 220 may be compressed with the use of a rolling mill and/or the like, for example. As a result of a region which has a relatively low aspect ratio of the active material and a relatively small amount of presence of the binder functioning as a cushion at the time of press work, the state of orientation of the active material is expected to be maintained.

### <Battery>

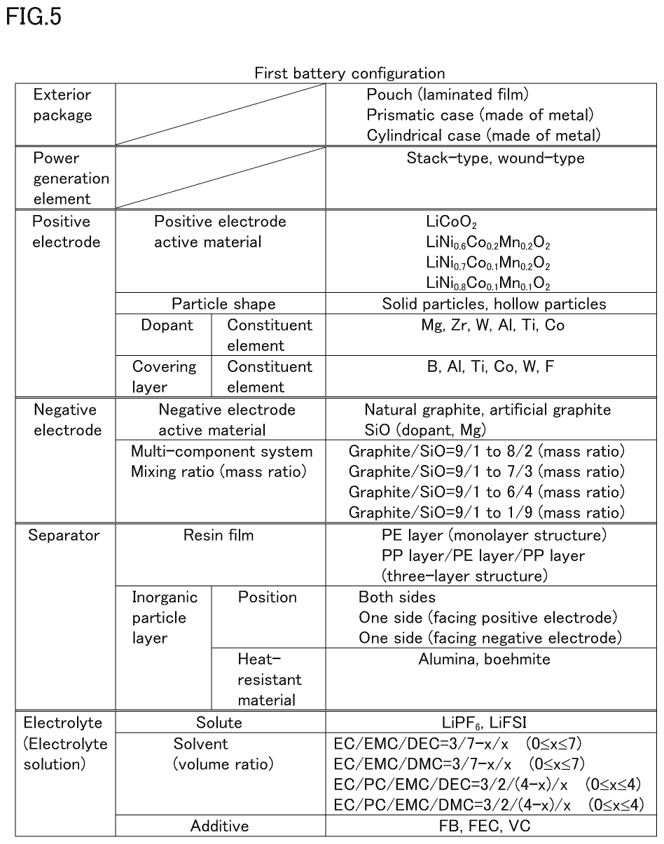

FIG. 4 is a conceptual view illustrating an example of a battery according to the present embodiment. A battery 1000 may be a monopolar-type lithium-ion battery, for example. Battery 1000 includes an exterior package 900. Exterior package 900 accommodates a power generation element 500 and an electrolyte solution (not illustrated).

### <Exterior Package>

Exterior package 900 may have any configuration. Exterior package 900 may be a case made of metal, a pouch made of a laminated film, and/or the like, for example. The case may have any shape. The case may be cylindrical, prismatic, flat, coin-shaped, and/or the like, for example. Exterior package 900 may include A1 and/or the like, for example. Exterior package 900 may accommodate one, two, or more power generation elements 500, for example. The plurality of power generation elements 500 may form a series circuit or a parallel circuit, for example. Inside exterior package 900, the plurality of power generation elements 500 may be stacked in the thickness direction of battery 1000.

### <Power Generation Element>

Power generation element 500 may also be called “an electrode group”, “an electrode assembly”, and the like. Power generation element 500 includes electrode 200 and a counter electrode 100. In the present embodiment, electrode 200 is a negative electrode. Counter electrode 100 is a positive electrode. Power generation element 500 may further include a separator 300. Separator 300 is interposed between the positive electrode and the negative electrode. Power generation element 500 may have any configuration. For example, power generation element 500 may be a stack-type one. For example, the positive electrode and the negative electrode may be alternately stacked with separator 300 interposed between the positive electrode and the negative electrode to form power generation element 500. For example, power generation element 500 may be a wound-type one. For example, a positive electrode having a belt-like shape, separator 300 having a belt-like shape, and a negative electrode having a belt-like shape may be stacked to form a stack. The resulting stack may be wound spirally to form power generation element 500. After being wound, the wound power generation element 500 may be shaped into a flat form.

### <Positive Electrode>

The positive electrode is in sheet form. The positive electrode may include a base material and a positive electrode active material layer. The base material is electrically conductive. The base material supports the positive electrode active material layer. The base material may be in sheet form, for example. The base material may have a thickness from 5 to 50 μm, for example. The base material may include a metal foil, for example. The base material may include at least one selected from the group consisting of Al, Mn, Ti, Fe, and Cr, for example. The base material may include an Al foil, an Al alloy foil, a Ti foil, a stainless steel (SUS) foil, and/or the like, for example.

Between the base material and the positive electrode active material layer, an intermediate layer may be formed. The intermediate layer does not include a positive electrode active material. The intermediate layer may have a thickness from 0.1 to 5 μm, for example. The intermediate layer may include a conductive material, an insulation material, a binder, and/or the like, for example. The conductive material may include carbon black and/or the like, for example. The insulation material may include alumina, boehmite, aluminum hydroxide, and/or the like, for example. The binder may include PVdF and/or the like, for example.

The positive electrode active material layer is placed on the surface of the base material. The positive electrode active material layer may be placed on only one side of the base material. The positive electrode active material layer may be placed on both sides of the base material. The thickness of the positive electrode active material layer may be from 10 to 1000 μm, or from 50 to 500 μm, or from 100 to 300 μm, for example. The positive electrode active material layer includes a positive electrode active material. The positive electrode active material layer may further include a conductive material, a binder, and the like, for example.

The amount of the conductive material to be used may be, for example, from 0.1 to 10 parts by mass relative to 100 parts by mass of the positive electrode active material. The conductive material may include any component. The conductive material may include at least one selected from the group consisting of graphite, AB, Ketjenblack, VGCFs, CNTs, and GFs, for example.

The amount of the binder to be used may be, for example, from 0.1 to 10 parts by mass relative to 100 parts by mass of the positive electrode active material. The binder may include any component. The binder may include at least one selected from the group consisting of PVdF, polyvinylidene difluoride-hexafluoropropylene copolymer (PVdF-HFP), PTFE, CMC, PAA, PVA, PVP, polyoxyethylene alkyl ether, and derivatives of these, for example.

The positive electrode active material layer may further include an inorganic filler, an organic filler, a solid electrolyte, a surface modifier, a dispersant, a lubricant, a flame retardant, a protective agent, a flux, a coupling agent, an adsorbent, and/or the like, for example. The positive electrode active material layer may include polyoxyethylene allylphenyl ether phosphate, zeolite, silane coupling agent, MoS₂, WO₃, and/or the like, for example.

The positive electrode active material may be in particle form, for example. The D50 of the positive electrode active material may be from 1 to 30 μm, or from 10 to 20 μm, or from 1 to 10 μm, for example. The positive electrode active material may include any component. The positive electrode active material may include a transition metal oxide, a polyanion compound, and/or the like, for example. In a single particle (positive electrode active material), the composition may be uniform, or may be non-uniform. For example, there may be a gradient in the composition from the surface of the particle toward the center. The composition may change continuously, or may change non-continuously (in steps).

### <Transition Metal Oxide (Space Group R-3m)>

The transition metal oxide may have any crystal structure. For example, the transition metal oxide may include a crystal structure that belongs to a space group R-3m and/or the like. For example, a compound represented by the general formula “LiMO₂” may have a crystal structure that belongs to a space group R-3m. The transition metal oxide may be represented by the following general formula, for example.

Li₁₋ₐNiₓM₁₋ₓO₂

In the above formula, the relationships of −0.5≤a≤0.5, 0≤x≤1 are satisfied. M may include, for example, at least one selected from the group consisting of Co, Mn, and A1. For example, the relationship of 0<x≤0.1, 0.1≤x≤0.2, 0.2≤x≤0.3, 0.3≤x≤0.4, 0.4≤x≤0.5, 0.5≤x≤0.6, 0.6≤x≤0.7, 0.7≤x≤0.8, 0.8≤x≤0.9, or 0.9≤x≤1 may be satisfied. For example, the relationship of −0.4≤a≤0.4, −0.3≤a≤0.3, −0.2≤a≤0.2, or −0.1≤a≤0.1 may be satisfied.

The transition metal oxide may include, for example, at least one selected from the group consisting of LiCoO₂, LiMnO₂, LiNi_{0.9}Co_{0.1}O₂, LiNi_{0.9}Mn_{0.1}O₂, and LiNiO₂.

### <NCM>

The transition metal oxide may be represented by the following general formula, for example. A compound represented by the following general formula may also be called “NCM”.

Li₁₋ₐNiₓCo_{y}Mn_{z}O₂

In the above formula, the relationships of −0.5≤a≤0.5, 0<x<1, 0<y<1, 0<z<1, x+y+z=1 are satisfied. For example, the relationship of 0<x≤0.1, 0.1≤x≤0.2, 0.2≤x≤0.3, 0.3≤x≤0.4, 0.4≤x≤0.5, 0.5≤x≤0.6, 0.6≤x≤0.7, 0.7≤x≤0.8, 0.8≤x≤0.9, or 0.9≤x<1 may be satisfied. For example, the relationship of 0<y≤0.1, 0.1≤y≤0.2, 0.2≤y≤0.3, 0.3≤y≤0.4, 0.4≤y≤0.5, 0.5≤y≤0.6, 0.6≤y≤0.7, 0.7≤y≤0.8, 0.8≤y≤0.9, or 0.9≤y<1 may be satisfied. For example, the relationship of 0<z≤0.1, 0.1≤z≤0.2, 0.2≤z≤0.3, 0.3≤z≤0.4, 0.4≤z≤0.5, 0.5≤z≤0.6, 0.6≤z≤0.7, 0.7≤z≤0.8, 0.8≤z≤0.9, or 0.9≤z<1 may be satisfied.

NCM may include, for example, at least one selected from the group consisting of LiNi_{1/3}Co_{1/3}Mn_{1/3}O₂, LiNi_{0.4}Co_{0.3}Mn_{0.3}O₂, LiNi_{0.3}Co_{0.4}Mn_{0.3}O₂, LiNi_{0.3}Co_{0.3}Mn_{0.4}O₂, LiNi_{0.5}Co_{0.2}Mn_{0.3}O₂, LiNi_{0.5}Co_{0.3}Mn_{0.2}O₂, LiNi_{0.5}Co_{0.4}Mn_{0.1}O₂, LiNi_{0.5}Co_{0.1}Mn_{0.4}O₂, LiNi_{0.6}Co_{0.2}Mn_{0.2}O₂, LiNi_{0.6}Co_{0.3}Mn_{0.1}O₂, LiNi_{0.6}Co_{0.1}Mn_{0.3}O₂, LiNi_{0.7}Co_{0.1}Mn_{0.2}O₂, LiNi_{0.7}Co_{0.2}Mn_{0.1}O₂, LiNi_{0.8}Co_{0.1}Mn_{0.1}O₂, and LiNi_{0.9}Co_{0.05}Mn_{0.05}O₂.

### <NCA>

The transition metal oxide may be represented by the following general formula, for example. A compound represented by the following general formula may also be called “NCA”.

Li₁₋ₐNiₓCo_{y}Al_{z}O₂

In the above formula, the relationships of −0.5≤a≤0.5, 0<x<1, 0<y<1, 0<z<1, x+y+z=1 are satisfied. For example, the relationship of 0<x≤0.1, 0.1≤x≤0.2, 0.2≤x≤0.3, 0.3≤x≤0.4, 0.4≤x≤0.5, 0.5≤x≤0.6, 0.6≤x≤0.7, 0.7≤x≤0.8, 0.8≤x≤0.9, or 0.9≤x<1 may be satisfied. For example, the relationship of 0<y≤0.1, 0.1≤y≤0.2, 0.2≤y≤0.3, 0.3≤y≤0.4, 0.4≤y≤0.5, 0.5≤y≤0.6, 0.6≤y≤0.7, 0.7≤y≤0.8, 0.8≤y≤0.9, or 0.9≤y<1 may be satisfied. For example, the relationship of 0<z≤0.1, 0.1≤z≤0.2, 0.2≤z≤0.3, 0.3≤z≤0.4, 0.4≤z≤0.5, 0.5≤z≤0.6, 0.6≤z≤0.7, 0.7≤z≤0.8, 0.8≤z≤0.9, or 0.9≤z<1 may be satisfied.

NCA may include, for example, at least one selected from the group consisting of LiNi_{0.7}Co_{0.1}Al_{0.2}O₂, LiNi_{0.7}Co_{0.2}Al_{0.1}O₂, LiNi_{0.8}Co_{0.1}Al_{0.1}O₂, LiNi_{0.8}Co_{0.17}Al_{0.03}O₂, LiNi_{0.8}Co_{0.15}Al_{0.05}O₂, and LiNi_{0.9}Co_{0.05}Al_{0.05}O₂.

### <Multi-Component System>

The positive electrode active material may include two or more NCMs and/or the like, for example. The positive electrode active material may include NCM (0.6≤x) and NCM (x<0.6), for example. “NCM (0.6≤x)” refers to a compound in which x (Ni ratio) in the general formula “Li₁₋ₐNiₓCo_{y}Mn_{z}O₂” is 0.6 or more. NCM (0.6≤x) may also be called “a high-nickel material”, for example. NCM (0.6≤x) includes LiNi_{0.8}Co_{0.1}Mn_{0.1}O₂ and/or the like, for example. “NCM (x<0.6)” refers to a compound in which x (Ni ratio) in the general formula “Li₁₋ₐNiₓCo_{y}Mn_{z}O₂” is less than 0.6. NCM (x<0.6) includes LiNi_{1/3}Co_{1/3}Mn_{1/3}O₂ and/or the like, for example. The mixing ratio (mass ratio) between NCM (0.6≤x) and NCM (x<0.6) may be “NCM (0.6≤x)/NCM (x<0.6)=9/1 to 1/9”, or “NCM (0.6≤x)/NCM (x<0.6)=9/1 to 4/6”, or “NCM (0.6≤x)/NCM (x<0.6)=9/1 to 3/7”, for example.

The positive electrode active material may include NCA and NCM, for example. The mixing ratio (mass ratio) between NCA and NCM may be “NCA/NCM=9/1 to 1/9”, or “NCA/NCM=9/1 to 4/6”, or “NCA/NCM=9/1 to 3/7”, for example. Between NCA and NCM, the Ni ratio may be the same or may be different. The Ni ratio of NCA may be more than the Ni ratio of NCM. The Ni ratio of NCA may be less than the Ni ratio of NCM.

### <Transition Metal Oxide (Space Group C2/m)>

The transition metal oxide may include a crystal structure that belongs to a space group C2/m and/or the like, for example. The transition metal oxide may be represented by the following general formula, for example.

Li₂MO₃

In the above formula, M may include at least one selected from the group consisting of Ni, Co, Mn, and Fe, for example. The positive electrode active material may include a mixture of LiMO₂ (space group R-3m) and Li₂MO₃ (space group C2/m), for example. The positive electrode active material may include a solid solution that is formed of LiMO₂ and Li₂MO₃ (Li₂MO₃-LiMO₂), and/or the like, for example.

### <Transition Metal Oxide (Space Group Fd-3m)>

The transition metal oxide may include a crystal structure that belongs to a space group Fd-3m and/or the like, for example. The transition metal oxide may be represented by the following general formula, for example.

LiMn₂₋ₓMₓO₄

In the above formula, the relationship of 0≤x≤2 is satisfied. M may include, for example, at least one selected from the group consisting of Ni, Fe, and Zn.

LiM₂O₄ (space group Fd-3m) may include, for example, at least one selected from the group consisting of LiMn₂O₄ and LiMn_{1.5}Ni_{0.5}O₄. The positive electrode active material may include a mixture of LiMO₂ (space group R-3m) and LiM₂O₄ (space group Fd-3m), for example. The mixing ratio (mass ratio) between LiMO₂ (space group R-3m) and LiM₂O₄ (space group Fd-3m) may be “LiMO₂/LiM₂O₄=9/1 to 1/9”, or “LiMO₂/LiM₂O₄=9/1 to 5/5”, or “LiMO₂/LiM₂O₄=9/1 to 7/3”, for example.

### <Polyanion Compound>

The polyanion compound may include a phosphoric acid salt (such as LiFePO₄, for example), a silicic acid salt, a boric acid salt, and/or the like, for example. The polyanion compound may be represented by any of the following general formulae, for example.

LiMPO₄

Li₂₋ₓMPO₄F

Li₂MSiO₄

LiMBO₃

In the above general formulae, M may include at least one selected from the group consisting of Fe, Mn, and Co, for example. In the above general formula “Li₂₋ₓMPO₄F”, the relationship of 0≤x≤2 may be satisfied, for example.

The positive electrode active material may include a mixture of LiMO₂ (space group R-3m) and the polyanion compound, for example. The mixing ratio (mass ratio) between LiMO₂ (space group R-3m) and the polyanion compound may be “LiMO₂/(polyanion compound)=9/1 to 1/9”, or “LiMO₂/(polyanion compound)=9/1 to 5/5”, or “LiMO₂/(polyanion compound)=9/1 to 7/3”, for example.

### <Dopant>

To the positive electrode active material, a dopant may be added. The dopant may be diffused throughout the entire particle, or may be locally distributed. For example, the dopant may be locally distributed on the particle surface. The dopant may be a substituted solid solution atom, or may be an intruding solid solution atom. The amount of the dopant to be added (the molar fraction relative to the total amount of the positive electrode active material) may be from 0.01 to 5%, or may be from 0.1 to 3%, or may be from 0.1 to 1%, for example. A single type of dopant may be added, or two or more types of dopant may be added. The two or more dopants may form a complex.

The dopant may include, for example, at least one selected from the group consisting of B, C, N, a halogen, Si, Na, Mg, Al, Mn, Co, Cr, Sc, Ti, V, Cu, Zn, Ga, Ge, Se, Sr, Y, Zr, Nb, Mo, In, Pb, Bi, Sb, Sn, W, La, Ce, Pr, Nd, Pm, Sm, Eu, Gd, Tb, Dy, Ho, Er, Tm, Yb, Lu, and an actinoid.

For example, to NCA, a combination of “Zr, Mg, W, Sm”, a combination of “Ti, Mn, Nb, Si, Mo”, or a combination of “Er, Mg” may be added. For example, to NCM, Ti may be added. For example, to NCM, a combination of “Zr, W”, a combination of “Si, W”, or a combination of “Zr, W, Al, Ti, Co” may be added.

### <Surface Covering>

The positive electrode active material may be in the form of composite particles. The composite particle may include a core particle and a covering layer, for example. The core particle includes the positive electrode active material. The covering layer covers at least part of the surface of the core particle. The thickness of the covering layer may be from 1 to 3000 nm, or from 5 to 2000 nm, or from 10 to 1000 nm, or from 10 to 100 nm, or from 10 to 50 nm, for example. The thickness of the covering layer may be measured in an SEM image of a cross section of the particle, for example. More specifically, the composite particle is embedded in a resin material to prepare a sample. With the use of an ion milling apparatus, a cross section of the sample is exposed. The cross section of the sample is examined by an SEM. For each of ten composite particles, the thickness of the covering layer is measured in twenty fields of view. The arithmetic mean of a total of these 200 thickness measurements is used.

The ratio of the part of the surface of the core particle covered by the covering layer is also called “a covering rate”. The covering rate may be 1% or more, or 10% or more, or 30% or more, or 50% or more, or 70% or more, for example. The covering rate may be 100% or less, or 90% or less, or 80% or less, for example.

For example, the covering rate may be measured by XPS (X-ray Photoelectron Spectroscopy). A powder sample consisting of the composite particle is set in the XPS. Narrow scan analysis is carried out. The measurement data is processed with analysis software. The measurement data is analyzed to detect a plurality of types of elements. From the area of each peak, the ratio of the detected element is determined. By the following equation, the covering rate is determined.

$$γ = \{ {I}_{1} / ( {I}_{0} + {I}_{1} ) \} \times 100$$

γ: Covering rate [%]

I₀: Ratio of element attributable to core particle

I₁: Ratio of element attributable to covering layer

For example, when the core particle includes NCM, I₀ represents the total ratio of the elements “Ni, Co, Mn”. For example, when the core particle includes NCA, I₀ represents the total ratio of the elements “Ni, Co, Al”. For example, when the covering layer includes P and B, I₁ represents the total ratio of the elements “P, B”.

The covering layer may include any component. The covering layer may include an elementary substance, organic matter, an inorganic acid salt, an organic acid salt, a hydroxide, an oxide, a carbide, a nitride, a sulfide, a halide, and/or the like, for example. The covering layer may include, for example, at least one selected from the group consisting of B, Al, W, Zr, Ti, Co, F, lithium compound (such as Li₂CO₃, LiHCO₃, LiOH, Li₂O, for example), tungsten oxide (such as WO₃, for example), titanium oxide (such as TiO₂, for example), zirconium oxide (such as ZrO₂, for example), boron oxide, boron phosphate (such as BPO₄, for example), aluminum oxide (such as Al₂O₃, for example), boehmite, aluminum hydroxide, phosphoric acid salt [such as Li₃PO₄, (NH₄)₃PO₄, AlPO₄, for example], boric acid salt (such as Li₂B₄O₇, LiBO₃, for example), polyacrylic acid salt (such as Li salt, Na salt, NH₄ salt), acetic acid salt (such as Li salt, for example), CMC (such as CMC-Na, CMC-Li, CMC-NH₄), LiNbO₃, Li₂TiO₃, and Li-containing halide (such as LiAlCl₄, LiTiAlF₆, LiYBr₆, LiYCl₆, for example).

### <Hollow Particles, Solid Particles>

Each of a hollow particle and a solid particle is a secondary particle. In a “hollow particle”, the area of the central cavity occupies at least 30% of the entire cross-sectional area of the particle in a cross-sectional image of the particle. The proportion of the cavity in a hollow particle may be 40% or more, or 50% or more, or 60% or more, for example. In a “solid particle”, the area of the central cavity occupies less than 30% of the entire cross-sectional area of the particle in a cross-sectional image of the particle. The proportion of the cavity in a solid particle may be 20% or less, or 10% or less, or 5% or less, for example. The positive electrode active material may be hollow particles, or may be solid particles. A mixture of hollow particles and solid particles may be used. The mixing ratio (mass ratio) between hollow particles and solid particles may be “(hollow particles)/(solid particles)=1/9 to 9/1”, or “(hollow particles)/(solid particles)=2/8 to 8/2”, or “(hollow particles)/(solid particles)=3/7 to 7/3”, or “(hollow particles)/(solid particles)=4/6 to 6/4”, for example.

### <Large Particles, Small Particles>

The active material may have a unimodal particle size distribution (based on the number), for example. The active material may have a multimodal particle size distribution, for example. The active material may have a bimodal particle size distribution, for example. That is, the active material may include large particles and small particles. When the particle size distribution is bimodal, the particle size corresponding to the peak top of the larger particle size is regarded as the particle size of the large particles, (d_{L}). The particle size corresponding to the peak top of the smaller particle size is regarded as the particle size of the small particles, (d_{S}). The particle size ratio (d_{L}/d_{S}) may be from 2 to 10, or from 2 to 5, or from 2 to 4, for example. d_{L} may be from 8 to 20 μm, or from 8 to 15 μm, for example. d_{S} may be from 1 to 10 μm, or from 1 to 5 μm, for example.

For example, with the use of waveform analysis software, peak separating processing may be carried out for the particle size distribution. The ratio between the peak area of the large particles, (S_{L}), and the peak area of the small particles, (S_{S}), may be “S_{L}/S_{S}=1/9 to 9/1”, or “S_{L}/S_{S}=5/5 to 9/1”, or “S_{L}/S_{S}=7/3 to 9/1”, for example.

The number-based particle size distribution is measured by a microscope method. From the active material layer, a plurality of cross-sectional samples are taken. The cross-sectional sample may include a cross section vertical to the surface of the active material layer, for example. By ion milling and/or the like, for example, cleaning is carried out to the side that is to be observed. By SEM, the cross-sectional sample is examined. The magnification for the examination is adjusted in such a way that 10 to 100 particles are contained within the examination field of view. The Feret diameters of all the particles in the image are measured. “Feret diameter” refers to the distance between two points located farthest apart from each other on the outline of the particle. The plurality of the cross-sectional samples are examined to obtain a total of 1000 or more Feret diameters. From the 1000 or more Feret diameters, number-based particle size distribution is created.

The bimodal particle size distribution may be formed by two types of particles mixed together. These two types of particles have different particle size distributions. For example, the two types of particles may have different D50. The sample to be measured is powder. The D50 of the large particles may be from 8 to 20 μm, or from 8 to 15 μm, for example. The D50 of the small particles may be from 1 to 10 μm, or from 1 to 5 μm, for example. The ratio of the D50 of the large particles to the D50 of the small particles may be from 2 to 10, or from 2 to 5, or from 2 to 4, for example. The mixing ratio (mass ratio) between the large particles and the small particles may be “(large particles)/(small particles)=1/9 to 9/1”, or “(large particles)/(small particles)=5/5 to 9/1”, or “(large particles)/(small particles)=7/3 to 9/1”, for example.

The large particles and the small particles may have the same composition, or may have different compositions. For example, the large particles may be NCA and the small particles may be NCM. For example, the large particles may be NCM (0.6≤x) and the small particles may be NCM (x<0.6).

### <Electrolyte Solution>

The electrolyte solution is a liquid electrolyte. The electrolyte solution includes a solute and a solvent. The concentration of the solute may be from 0.5 to 1 mol/L, or from 1 to 1.5 mol/L, or from 1.5 to 2 mol/L, or from 2 to 2.5 mol/L, or from 2.5 to 3 mol/L, for example. “Mol/L” may also be expressed as “M”. The solute includes a supporting salt (a Li salt). The solute may include an inorganic acid salt, an imide salt, an oxalato complex, a halide, and/or the like, for example. The solute may include, for example, at least one selected from the group consisting of LiPF₆, LiBF₄, LiClO₄, LiAsF₆, LiSbF₆, LiN(SO₂F)₂ “LiFSI”, LiN(SO₂CF₃)₂ “LiTFSI”, LiB(C₂O₄)₂ “LiBOB”, LiBF₂(C₂O₄) “LiDFOB”, LiPF₂(C₂O₄)₂ “LiDFOP”, LiPO₂F₂, FSO₃Li, LiI, LiBr, and derivatives of these.

The electrolyte solution may include a carbonate-based solvent (a carbonate-ester-based solvent), for example. The solvent may include a cyclic carbonate, a chain carbonate, a fluorinated carbonate, and/or the like, for example. The solvent may include, for example, at least one selected from the group consisting of ethylene carbonate (EC), propylene carbonate (PC), butylene carbonate (BC), dimethyl carbonate (DMC), diethyl carbonate (DEC), ethyl methyl carbonate (EMC), monofluoroethylene carbonate (FEC), difluoroethylene carbonate, 4,4-difluoroethylene carbonate, trifluoroethylene carbonate, perfluoroethylene carbonate, fluoropropylene carbonate, difluoropropylene carbonate, and derivatives of these.

The solvent may include a cyclic carbonate (such as EC, PC, FEC) and a chain carbonate (such as EMC, DMC, DEC). The mixing ratio (volume ratio) between the cyclic carbonate and the chain carbonate may be “(cyclic carbonate)/(chain carbonate)=1/9 to 4/6”, or “(cyclic carbonate)/(chain carbonate)=2/8 to 3/7”, or “(cyclic carbonate)/(chain carbonate)=3/7 to 4/6”, for example.

The solvent may include a cyclic carbonate (such as EC, PC) and a fluorinated cyclic carbonate (such as FEC). The mixing ratio (volume ratio) between the cyclic carbonate and the fluorinated cyclic carbonate may be “(cyclic carbonate)/(fluorinated cyclic carbonate)=99/1 to 90/10”, or “(cyclic carbonate)/(fluorinated cyclic carbonate)=9/1 to 1/9”, or “(cyclic carbonate)/(fluorinated cyclic carbonate)=9/1 to 7/3”, or “(cyclic carbonate)/(fluorinated cyclic carbonate)=3/7 to 1/9”, for example.

The solvent may include EC, FEC, EMC, DMC, and DEC, for example. The volume ratio of these components may satisfy the relationship represented by the following equation, for example.

$${V}_{EC} + {V}_{FEC} + {V}_{EMC} + {V}_{DMC} + {V}_{DEC} = 10$$

In the above equation, each of V_{EC}, V_{FEC}, V_{EMC}, V_{DMC}, and V_{DEC} represents the volume ratio of EC, FEC, EMC, DMC, and DEC, respectively.

The relationships of 1≤V_{EC}≤4, 0≤V_{FEC}≤3, V_{EC}+V_{FEC}≤4, 0≤V_{EMC}≤9, 0≤V_{DMC}≤9,0≤V_{DEC}≤9,6≤V_{EMC}+V_{DMC}+V_{DEC}≤9 are satisfied.

For example, the relationship of 1≤V_{EC}≤2 or 2≤V_{EC}≤3 may be satisfied.

For example, the relationship of 1≤V_{FEC}≤2 or 2≤V_{FEC}≤4 may be satisfied.

For example, the relationship of 3≤V_{EMC}≤4 or 6≤V_{EMC}≤8 may be satisfied.

For example, the relationship of 3≤V_{DMC}≤4 or 6≤V_{DMC}≤8 may be satisfied.

For example, the relationship of 3≤V_{DEC}≤4 or 6≤V_{DEC}≤8 may be satisfied.

The solvent may have a composition of “EC/EMC=3/7”, “EC/DMC=3/7”, “EC/FEC/DEC=1/2/7”, “EC/DMC/EMC=3/4/3”, “EC/DMC/EMC=3/3/4”, “EC/FEC/DMC/EMC=2/1/4/3”, “EC/FEC/DMC/EMC=1/2/4/3”, “EC/FEC/DMC/EMC=2/1/3/4”, “EC/FEC/DMC/EMC=1/2/3/4” (volume ratio), and/or the like, for example.

The electrolyte solution may include an ether-based solvent. The electrolyte solution may include, for example, at least one selected from the group consisting of tetrahydrofuran (THF), 1,4-dioxane (DOX), 1,3-dioxolane (DOL), 1,2-dimethoxyethane (DME), 1,2-diethoxyethane (DEE), hydrofluoroether (HFE), ethylglyme, triglyme, tetraglyme, and derivatives of these.

The electrolyte solution may include any additive. The amount to be added (the mass fraction to the total amount of the electrolyte solution) may be from 0.01 to 5%, or from 0.05 to 3%, or from 0.1 to 1%, for example. The additive may include an SEI (Solid Electrolyte Interphase) formation promoter, an SEI formation inhibitor, a gas generation agent, an overcharging inhibitor, a flame retardant, an antioxidant, an electrode-protecting agent, a surfactant, and/or the like, for example.

The additive may include, for example, at least one selected from the group consisting of vinylene carbonate (VC), vinylethylene carbonate (VEC), 1,3-propane sultone (PS), tert-amylbenzene, 1,4-di-tert-butylbenzene, biphenyl (BP), cyclohexylbenzene (CHB), ethylene sulfite (ES), propane sultone (PS), ethylene sulfate (DTD), γ-butyrolactone, phosphazene compound, carboxylate ester [such as methyl formate (MF), methyl acetate (MA), methyl propionate (MP), diethyl malonate (DEM), for example], fluorobenzene (such as monofluorobenzene (FB), 1,2-difluorobenzene, 1,3-difluorobenzene, 1,4-difluorobenzene, 1,2,3-trifluorobenzene, 1,2,4-trifluorobenzene, 1,3,5-trifluorobenzene, 1,2,3,4-tetrafluorobenzene, 1,2,3,5-tetrafluorobenzene, 1,2,4,5-tetrafluorobenzene, pentafluorobenzene, hexafluorobenzene, for example), fluorotoluene (such as 2-fluorotoluene, 3-fluorotoluene, 4-fluorotoluene, 2,3-difluorotoluene, 2,4-difluorotoluene, 2,5-difluorotoluene, 2,6-difluorotoluene, 3,4-difluorotoluene, octafluorotoluene, for example), benzotrifluoride (such as benzotrifluoride, 2-fluorobenzotrifluoride, 3-fluorobenzotrifluoride, 4-fluorobenzotrifluoride, 2-methylbenzotrifluoride, 3-methylbenzotrifluoride, 4-methylbenzotrifluoride, for example), fluoroxylene (such as 3-fluoro-o-xylene, 4-fluoro-o-xylene, 2-fluoro-m-xylene, 5-fluoro-m-xylene, for example), sulfur-containing heterocyclic compound (such as benzothiazole, 2-methylbenzothiazole, tetrathiafulvalene, for example), nitrile compound (such as adiponitrile, succinonitrile, for example), phosphate (such as trimethyl phosphate, triethyl phosphate, for example), carboxylic anhydride (such as acetic anhydride, propionic anhydride, oxalic anhydride, succinic anhydride, maleic anhydride, phthalic anhydride, benzoic anhydride, for example), alcohol (such as methanol, ethanol, n-propyl alcohol, ethylene glycol, diethylene glycol monomethyl ether, for example), and derivatives of these.

The components described above as the solute and the solvent may be used as a trace component (an additive). The additive may include, for example, at least one selected from the group consisting of LiBF₄, LiFSI, LiTFSI, LiBOB, LiDFOB, LiDFOP, LiPO₂F₂, FSO₃Li, LiI, LiBr, HFE, DOX, PC, FEC, and derivatives of these.

The electrolyte solution may include an ionic liquid. The ionic liquid may include, for example, at least one selected from the group consisting of a sulfonium salt, an ammonium salt, a pyridinium salt, a piperidinium salt, a pyrrolidinium salt, a morpholinium salt, a phosphonium salt, an imidazolium salt, and derivatives of these.

### <Gelled Electrolyte>

Battery 1000 may include a gelled electrolyte. The gelled electrolyte may include an electrolyte solution and a polymer material. The polymer material may form a polymer matrix. The polymer material may include, for example, at least one selected from the group consisting of PVdF, PVdF-HFP, PAN, PVdF-PAN, polyethylene oxide (PEO), polyethylene glycol (PEG), and derivatives of these.

### <Separator>

Separator 300 is capable of separating the positive electrode from the negative electrode. Separator 300 is electrically insulating. Separator 300 may include at least one selected from the group consisting of a resin film, an inorganic particle layer, and an organic particle layer, for example. Separator 300 may include a resin film and an inorganic particle layer, for example.

The resin film is porous. The resin film may include a microporous film, a nonwoven fabric, and/or the like, for example. The resin film includes a resin skeleton. The resin skeleton may be continuous in mesh form, for example. Gaps in the resin skeleton form pores. The resin film allows an electrolyte to permeate therethrough. The resin film may have an average pore size of 1 μm or less, for example. The average pore size of the resin film may be from 0.01 to 1 μm, or from 0.1 to 0.5 μm, for example. “Average pore size” may be measured by mercury porosimetry. The Gurley value of the resin film may be from 50 to 250 s/100 cm³, for example. “Gurley value” may be measured by a Gurley test method.

The resin film may include, for example, at least one selected from the group consisting of an olefin-based resin, a polyurethane-based resin, a polyamide-based resin, a cellulose-based resin, a polyether-based resin, an acrylic-based resin, a polyester-based resin, and the like. The resin film may include, for example, at least one selected from the group consisting of polyethylene (PE), polypropylene (PP), polyamide (PA), polyamide-imide (PAI), polyimide (PI), aromatic polyamide (aramid), polyphenylene ether (PPE), and derivatives of these. The resin film may be formed by stretching, phase separation, and/or the like, for example. The thickness of the resin film may be from 5 to 50 μm, or from 10 to 25 μm, for example.

The resin film may have a monolayer structure. The resin film may consist of a PE layer, for example. A skeleton of a PE layer is formed of PE. The PE layer may have shut-down function. The resin film may have a multilayer structure, for example. The resin film may include a PP layer and a PE layer, for example. A skeleton of a PP layer is formed of PP. The resin film may have a three-layer structure, for example. The resin film may be formed by stacking a PP layer, a PE layer, and a PP layer in this order, for example. The thickness of the PE layer may be from 5 to 20 μm, for example. The thickness of the PP layer may be from 3 to 10 μm, for example.

The inorganic particle layer may be formed on the surface of the resin film. The inorganic particle layer may be formed on only one side of the resin film, or may be formed on both sides of the resin film. The inorganic particle layer may be formed on the side facing the positive electrode, or may be formed on the side facing the negative electrode. The inorganic particle layer may be formed on the surface of the positive electrode, or may be formed on the surface of the negative electrode.

The inorganic particle layer is porous. The inorganic particle layer includes inorganic particles. The inorganic particles may also be called “an inorganic filler”. Gaps between the inorganic particles form pores. The thickness of the inorganic particle layer may be from 0.5 to 10 μm, or from 1 to 5 μm, for example. The inorganic particles may include a heat-resistant material, for example. The inorganic particle layer that includes a heat-resistant material is also called “HRL (Heat Resistance Layer)”. The inorganic particles may include at least one selected from the group consisting of boehmite, alumina, zirconia, titania, magnesia, silica, and the like. The inorganic particles may have any shape. The inorganic particles may be spherical, rod-like, plate-like, fibrous, and/or the like, for example. The D50 of the inorganic particles may be from 0.1 to 10 μm, or from 0.5 to 3 μm, for example. The inorganic particle layer may further include a binder. The binder may include, for example, at least one selected from the group consisting of an acrylic-based resin, a polyamide-based resin, a fluorine-based resin, an aromatic-polyether-based resin, and a liquid-crystal-polyester-based resin, and the like.

Separator 300 may include an organic particle layer, for example. Separator 300 may include an organic particle layer instead of the resin film, for example. Separator 300 may include an organic particle layer instead of the inorganic particle layer, for example. Separator 300 may include both the resin film and an organic particle layer. Separator 300 may include both the inorganic particle layer and an organic particle layer. Separator 300 may include the resin film, the inorganic particle layer, and an organic particle layer.

The thickness of the organic particle layer may be from 0.1 to 50 μm, or from 0.5 to 20 μm, or from 0.5 to 10 μm, or from 1 to 5 μm, for example. The organic particle layer includes organic particles. The organic particles may also be called “an organic filler”. The organic particles may include a heat-resistant material. The organic particles may include, for example, at least one selected from the group consisting of PE, PP, PTFE, PI, PAI, PA, aramid, and the like. The organic particles may be spherical, rod-like, plate-like, fibrous, and/or the like, for example. The D50 of the organic particles may be from 0.1 to 10 μm, or from 0.5 to 3 μm, for example.

Separator 300 may include a mixed layer, for example. The mixed layer includes both inorganic particles and organic particles.

### <Battery Configuration>

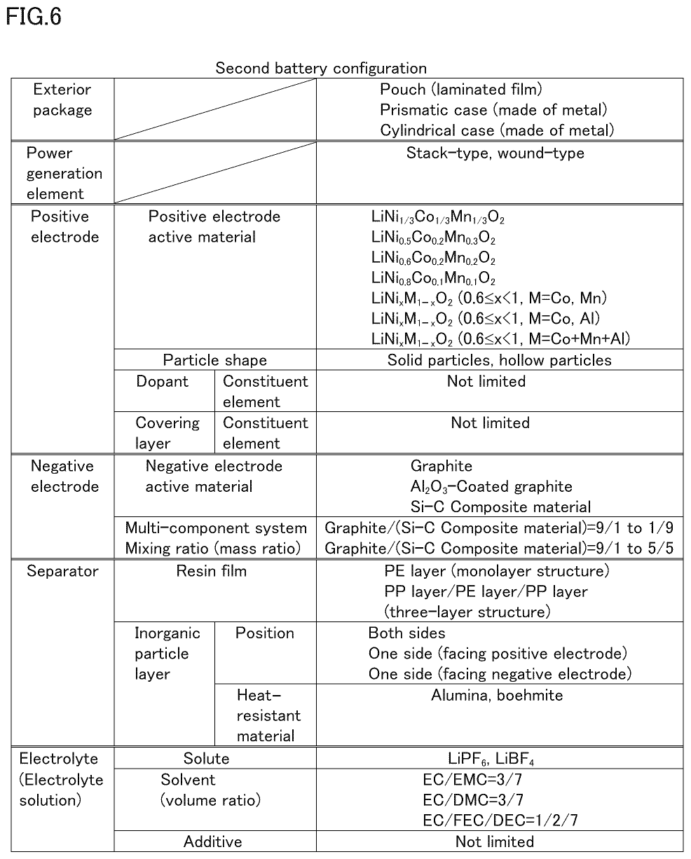

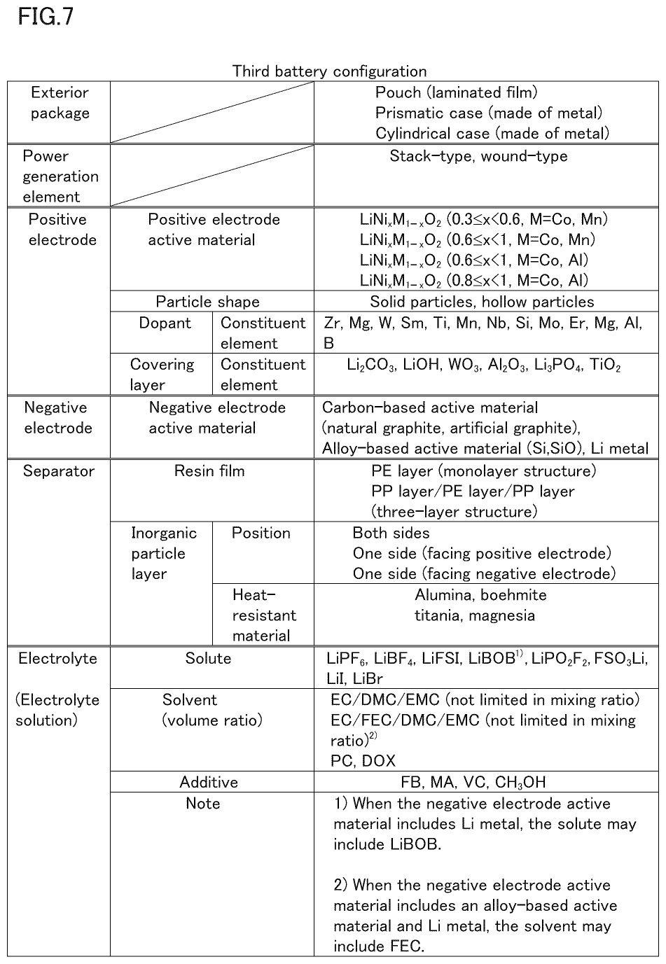

FIG. 5 is a table showing a first battery configuration. FIG. 6 is a table showing a second battery configuration. FIG. 7 is a table showing a third battery configuration. In each table, when a plurality of materials are described in a single cell, this description is intended to mean one of them as well as a combination of them. For example, when materials “α, β, γ” are described in a single cell, this description is intended to mean “at least one selected from the group consisting of α, β, and γ”. Certain elements may be extracted from the first battery configuration, the second battery configuration, and the third battery configuration and optionally combined together.

### EXAMPLES

### <Production of Evaluation-Purpose Electrode>

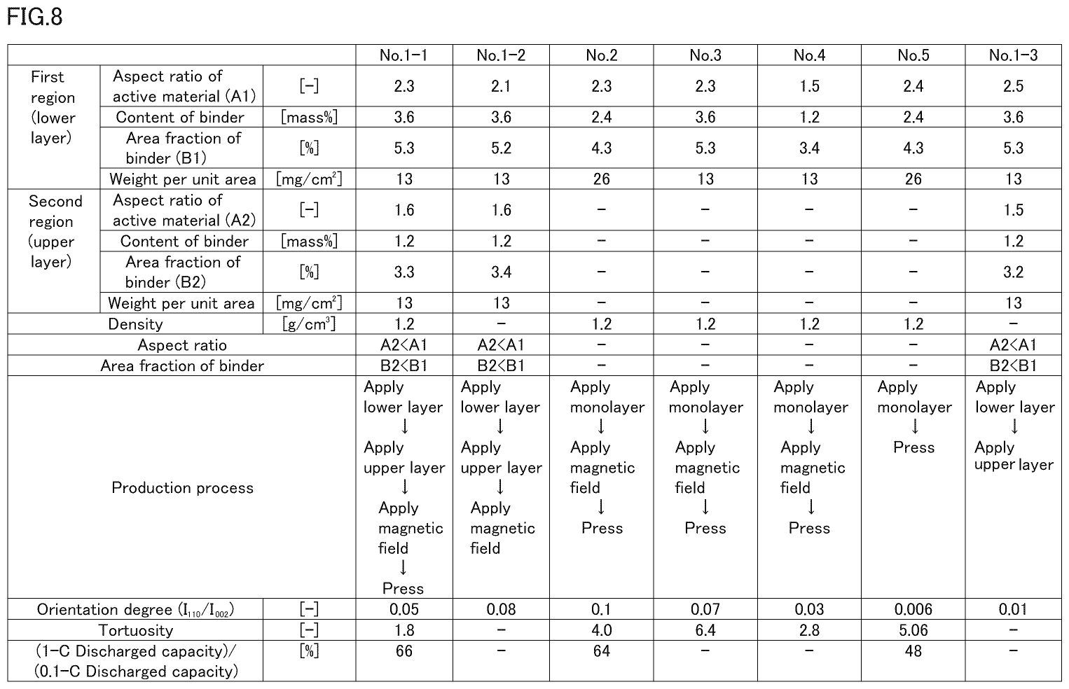

FIG. 8 is a table showing experiment results. By the below procedure, various evaluation-purpose electrodes (negative electrodes) were produced.

### <No. 1-1>

### Production of Negative Electrode

The below materials were prepared.

Active material: Graphite A (flake-shaped particles, artificial graphite), graphite B (spherical particles, artificial graphite)

Binder: SBR

Thickening material: CMC

Dispersion medium: Water

Base material: Cu foil (thickness, 15 μm)

### (a) Applying Lower Layer

Graphite A, SBR, CMC, and water were mixed to prepare a first slurry. The solid matter blending ratio was “(graphite A)/CMC/SBR=95.8/0.6/3.6 (mass ratio)”. The first slurry was applied to the base material, and thereby a first region (a lower layer) was formed. The first region was formed in such a manner that the weight thereof per unit area after drying became 13 mg/cm².

### (b) Applying Upper Layer

Graphite B, SBR, CMC, and the dispersion medium were mixed to prepare a second slurry. The solid matter blending ratio was “(graphite B)/CMC/SBR=98.2/0.6/1.2 (mass ratio)”. The second slurry was applied over the first slurry, and thereby a second region (an upper layer) was formed. The second region was formed in such a manner that the weight thereof per unit area after drying became 13 mg/cm².

### (c) Orienting Magnetic Field

To the coating films (the first region and the second region), a magnetic field was applied.

### (d) Drying

The coating films were dried, and thereby a negative electrode active material layer was formed.

### (e) Pressing

The resulting negative electrode active material layer was compressed. After compression, the density of the negative electrode active material layer was 1.2 g/cm³. In this manner, a negative electrode was produced. For each region in a cross-sectional sample of the negative electrode active material layer, the aspect ratio of the active material and the area fraction of the binder were measured. Further, the orientation degree and the tortuosity of the negative electrode active material layer were measured.

### <No. 1-2>

The negative electrode No. 1-2 is No. 1-1 before pressing.

### <No. 1-3>

No. 1-3 is No. 1-1 before magnetic field application.

### <No. 2>

Graphite A, SBR, CMC, and water were mixed to prepare a slurry. The solid matter blending ratio was “(graphite A)/CMC/SBR=97/0.6/2.4 (mass ratio)”. The resulting slurry was applied to the base material, and thereby a coating film (monolayer) was formed. The negative electrode active material layer was formed in such a manner that the weight thereof per unit area after drying became 26 mg/cm². To the coating film, a magnetic field was applied. The coating film was dried, and thereby a negative electrode active material layer was formed. The resulting negative electrode active material layer was compressed. After compression, the density of the negative electrode active material layer was 1.2 g/cm³. In this manner, a negative electrode was produced.

### <No. 3>

A negative electrode was produced in the same manner as for No. 2 except that the solid matter blending ratio was changed to “(graphite A)/CMC/SBR=95.8/0.6/3.6 (mass ratio)”.

### <No. 4>

A negative electrode was produced in the same manner as for No. 2 except that the solid matter blending ratio was changed to “(graphite B)/CMC/SBR=98.2/0.6/1.2 (mass ratio)”.

### <No. 5>

A negative electrode was produced in the same manner as for No. 2 except that a magnetic field was not applied to the coating film.

### <Production of Evaluation-Purpose Cell>

An evaluation-purpose cell (a laminate-type cell) including the negative electrode obtained in the above-described manner was produced. The rated capacity of the evaluation-purpose cell was 155 mAh.

### Production of Positive Electrode

The below materials were prepared.

Positive electrode active material: LiNi_{0.8}Co_{0.1}Mn_{0.1}O₂ (NCM)

Conductive material: AB

Binder: PVdF

Dispersion medium: N-methyl-pyrrolidone (NMP)

Base material: Al foil (thickness, 30 μm)

NCM, AB, PVdF, and NMP were mixed to prepare a slurry. The solid matter blending ratio was “NCM/AB/PVdF=97.8/0.8/1.4 (mass ratio)”. The resulting slurry was applied to the base material, and thereby a positive electrode active material layer was formed. The resulting positive electrode active material layer was dried. The positive electrode active material layer was compressed, and thereby a positive electrode was produced.

Assembly

The below materials were prepared.

Separator: Porous sheet made of PE

Electrolyte solution: 1.0-mol/L LiPF₆, EC+DMC+EMC

Exterior package: Pouch made of A1-laminated film

The positive electrode, the separator, and the negative electrode were stacked in this order, and thereby a power generation element was formed. The resulting power generation element and the electrolyte solution were sealed into the exterior package, and thereby an evaluation-purpose cell was produced.

### <Evaluation>

Discharged capacity of the evaluation-purpose cell at 0.1 C and 1 C was measured. The ambient temperature during discharging was 25° C. The ratio of the capacity during discharging at 1 C (1-C discharged capacity) to the capacity during discharging at 0.1 C (0.1-C discharged capacity), which was ((1-C discharged capacity)/(0.1-C discharged capacity)), was calculated. The greater the (1-C discharged capacity)/(0.1-C discharged capacity) is, the better the rate performance is conceivable to be.

### <Results>

From the orientation degree of No. 1-1, No. 1-2, and No. 1-3, it is indicated that the magnetic field application tends to increase the orientation degree. From the orientation degree of No. 1-1 and No. 1-2, the state of orientation seems to be maintained in No. 1-1 after pressing. In No. 1-1, the relationships of “A2<A1” and “B2<B1” are satisfied. It is conceivable that as a result of the second region which has a relatively low aspect ratio of the active material and a relatively small amount of presence of the binder functioning as a cushion, the state of orientation tends not to change.

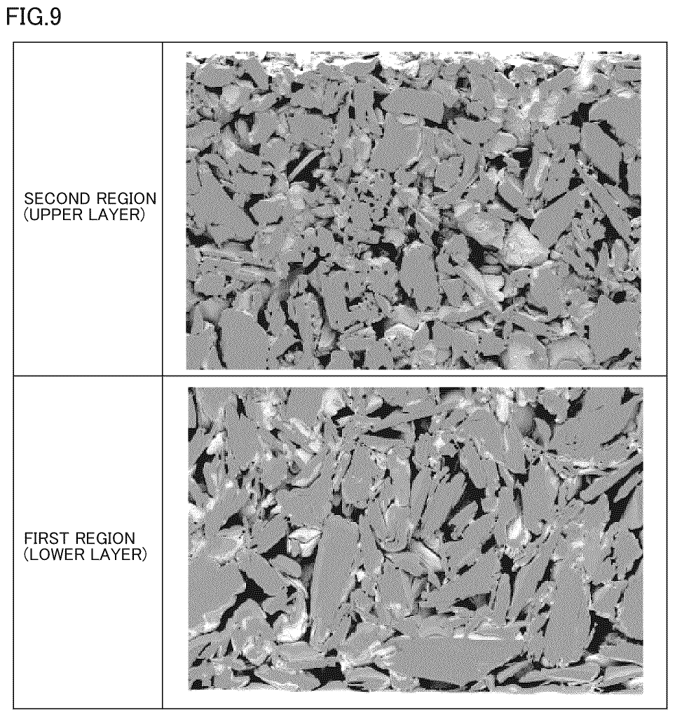

FIG. 9 shows cross-sectional SEM images of the first region and the second region in No. 1-1. In the first region (a lower layer), it seems that flake-shaped particles with a relatively high aspect ratio are oriented in the thickness direction. In the second region (an upper layer), spherical particles with a relatively low aspect ratio are distributed.

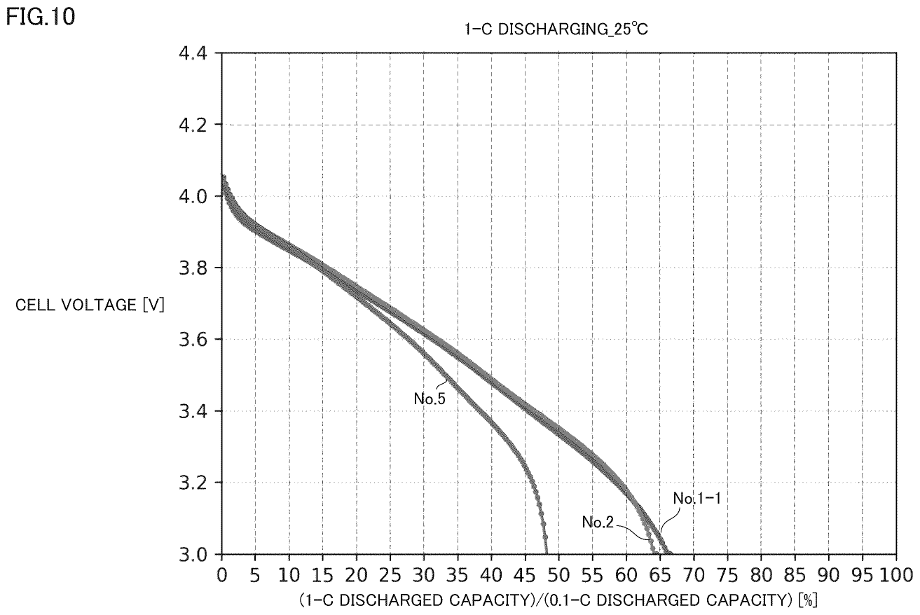

FIG. 10 is a discharge curve during discharging at 1 C. No. 1-1 and No. 2 tend to have better rate performance as compared to No. 5. No. 1-1 and No. 2 have great orientation degrees as compared to No. 5. No. 1-1 tends to have better rate performance as compared to No. 2. No. 1-1 has a small tortuosity as compared to No. 2. The negative electrode active material layer of No. 1-1 includes a first region and a second region. The negative electrode active material layer of No. 2 consists of one region.

What is claimed is:

1. An electrode for a battery, the electrode comprising:
a base material; and
a negative electrode active material layer, wherein
the negative electrode active material layer is placed on a surface of the base material,
a cross section of the negative electrode active material layer parallel to a thickness direction includes a first region and a second region,
in the thickness direction, the first region is interposed between the second region and the base material,
the first region includes a first active material and a first binder,
the second region includes a second active material and a second binder, and
either a set of relationships of the following expression (1) and the following expression (2) or a set of relationships of the following expression (3) and the following expression (4) is satisfied:
$$A 2 < A 1 \qquad ( 1 )$$
$$B 2 < B 1 \qquad ( 2 )$$
$$A 2 > A 1 \qquad ( 3 )$$
$$B 2 > B 1 \qquad ( 4 )$$
where
A1 represents an aspect ratio of the first active material,
A2 represents an aspect ratio of the second active material,
B1 represents an area fraction of the first binder in the first region, and
B2 represents an area fraction of the second binder in the second region.

2. The electrode for a battery according to claim 1, wherein the negative electrode active material layer has a tortuosity of 1.8 or less.

3. The electrode for a battery according to claim 1, wherein a relationship of the following expression (5) is further satisfied:
$$0.05 \leq {I}_{110} / {I}_{002} \qquad ( 5 )$$
where
I₁₁₀ represents a diffraction intensity of a (110) plane in an X-ray diffraction profile of the negative electrode active material layer, and
I₀₀₂ represents a diffraction intensity of a (002) plane in the X-ray diffraction profile of the negative electrode active material layer.

4. The electrode for a battery according to claim 1, wherein among the set of relationships of the expression (1) and the expression (2) and the set of relationships of the expression (3) and the expression (4), only the set of relationships of the expression (1) and the expression (2) is satisfied.

5. The electrode for a battery according to claim 1, wherein each of the first active material and the second active material independently includes artificial graphite.

6. The electrode for a battery according to claim 1, wherein the negative electrode active material layer has a weight of 20 mg/cm² or more per unit area and a density from 1.1 to 1.6 g/cm³.

7. The electrode for a battery according to claim 1, wherein a relationship of the following expression (6) is further satisfied:
$$0.5 \leq Tx / ( T 1 + T 2 ) \leq 0.7 \qquad ( 6 )$$
where
T1 represents a thickness of the first region, and
T2 represents a thickness of the second region,
when the relationship of the expression (1) is satisfied, Tx represents the thickness of the first region, and
when the relationship of the expression (3) is satisfied, Tx represents the thickness of the second region.

8. The electrode for a battery according to claim 1, wherein a relationship of the following expression (7) is further satisfied:
$$1.8 \% \leq \vert B 1 - B 2 \vert . \qquad ( 7 )$$

9. The electrode for a battery according to claim 1, wherein a relationship of the following expression (8) is further satisfied:
$$1.8 \leq Ax \qquad ( 8 )$$
where
when the relationship of the expression (1) is satisfied, Ax represents the aspect ratio of the first active material, and
when the relationship of the expression (3) is satisfied, Ax represents the aspect ratio of the second active material.

10. A battery comprising the electrode for a battery according to claim 1.
